(19) United States
(12) Patent Application Publication
(10) Pub. No.: US 2020/0349489 A1
(43) Pub. Date: Nov. 5, 2020

(54) Method and System for Remote Real-Time, Transporting and Distribution of Compressed Gaseous Fuels

(71) Applicant: Neogas Do Brasil Gás Natural Comprimido S.A., Caxias Do Sul (BR)

(72) Inventors: Antonio de Azevedo, Caxias do Sul -RS (BR); Jocemar Muller Boeira, Caxias do Sul -RS (BR); Luis Carlos Blanco Linares, Caxias do Sul -RS (BR)

(73) Assignee: Neogas Do Brasil Gás Natural Comprimido S.A., Caxias Do Sul (BR)

(21) Appl. No.: 16/400,658

(22) Filed: May 1, 2019

(51) Int. Cl. G06Q 10/06; G06Q 10/08; G06F 16/25; F17C 13/02; G06F 16/182

(52) U.S. Cl. CPC G06Q 10/06315; G06Q 10/06393; G06Q 10/0832; G06Q 50/06; F17C 13/02; G06F 16/182; G06F 16/25

(57) ABSTRACT

The present invention is directed to a method and system, for remote real-time transporting and distribution of compressed gas aiming to make faster, more efficient and at a lower cost, both the compression process and the process of distribution and delivery of compressed gaseous fuels by controlling physical and logistics parameters related to a gas from a pipeline which should be compressed, transported and delivered to the final customer. The method merges the following databases of a real-time remote system: telemetry 116, logistics 118, assets control maintenance and Enterprise Resource Planning (ERP) 119.

The present invention is directed to a method and system, for remote real-time transporting and distribution of compressed gas aiming to make faster, more efficient and at a lower cost, both the compression process and the process of distribution and delivery of compressed gaseous fuels by controlling physical and logistics parameters related to a gas from a pipeline which should be compressed, transported and delivered to the final customer. The method merges the following databases of a real-time remote system: telemetry 116, logistics 118, assets control maintenance and Enterprise Resource Planning (ERP) 119. As such, the present method comprises collecting and controlling the main physical and logistics variables related to gaseous fuel distribution by making the database integration of different systems that control: gas loading at at least one full instrumented gas compression station CS 112, obtaining gas-loaded high-pressure, electronically identified, container; transporting, tracking and distributing said gas-loaded container by remote controlling; gas unloading using different real-time remote monitored and controlled processing equipment to deliver gas at at least one delivery point DP 113; and a remote assets identification system based on either a code bar tag or a radio frequency tag identification.

### BACKGROUND OF THE INVENTION

### Field of the Invention

The present invention refers to an operational real-time monitoring and transporting method and system for compressed gaseous fuel distribution network based on gaseous fuel compression at a loading station, using high-pressure trailers for transportation, and different types of unloading equipment for gaseous fuel delivery/distribution.

### Description of Related Art

Fossil gaseous fuels result from the decomposition of organic material within Earth. Among gaseous fuels, for example, natural gas can be found in subsoil ground or seabed. It can also be obtained by biological decomposition of organic residues, as is the case of bio-methane that is a combustible gas consisting mainly of methane derived from the purification of biogas.

Natural gas is composed of a variable mixture of gases, where methane (CH₄) is predominant, with levels above 70%. Its density is lower than 0.0084 lb/gal, i.e. it is lighter than atmospheric air, which causes it to rapidly disperse in the atmosphere in case of leakage, which is a great benefit regarding safety.

Natural Gas is odorless and colorless in nature, being usually artificially odorized before distribution to the final consumer. Its combustion results in carbon dioxide and water vapor, which makes it a secure energy, low-emission source, and able to be used in industry, commerce and household's vehicles.

In industry, it is used as a heat source, power generation, and driving force, as well as raw material for the chemical and petrochemical industries as well as fertilizers. It is also used in the transportation sector, in view of the increase of green fleet which has been gaining more space. In homes and buildings, it is often used as fuel for space heating, water and even for cooking.

Thus, natural gas becomes a very competitive source of energy, having lower cost and reduced emissions compared to other fossil fuels.

After extraction and treatment to achieve the required specifications, natural gas is conveyed for consumption by physical gas pipelines.

The construction of physical gas pipelines, particularly in steep terrain and urban areas, may represent major investment costs, which can only be justified by high levels of consumption.

Where there is no justification for large consumption, physical gas pipelines may not be feasible. Due to that, regions with small-scale demands can be supplied using Compressed Natural Gas (CNG) transportation on wheels.

CNG distribution on wheels is also dependent on a pipeline, as it is obtained from processed natural gas. In an area where there is a pipeline, not too far from the delivery point that needs natural gas, the distribution on wheels is an option.

Currently, this demand can be supplied by building a Compressed Natural Gas Station connected to the pipeline. This station is responsible for loading the trailers which carry out the CNG transportation. The compression station has the function of raising the gas pressure obtained in the pipeline, usually between 150 to 750 psi, to pressures ranging from 3,600 to 4,500 psi. This process is accomplished by natural gas compressors that compress and transfer the compressed gaseous fuel to trailers.

The trailers are responsible for transporting natural gas at high pressure and volume from the Compression Station to the delivery point where a reduction and control unit is installed to supply gas to the customer at pressures and temperatures like those supplied by the pipeline.

Depending on the process the customer is interested in, for instance the one that is ordinarily used in a natural gas service station, the trailer's high pressure can be used for gas transfer assisted by either a booster or hydraulic power unit to perform the gas transfer from the trailer vessel to the vehicle cylinder (for example, in the case of natural gas-powered cars).

This last part of the process for industrial/commercial and vehicular customers close the loop that starts at the compression station and is completed at the delivery point.

The patent literature offers a series of documents related on the one side to the distribution of compressed gases by virtual means, and on the other side, documents related to the remote, real-time monitoring or management.

Thus, in US Published Application US 20150032886A1 a remote real-time monitoring system based on cloud computing is disclosed, comprising: a monitored terminal which is a terminal for collecting data and processing control on site, a management terminal which is a user terminal for performing remote monitoring and managing on the monitored terminal, and a cloud monitoring platform. The monitored terminal and the management terminal are connected to the cloud monitoring platform through a network comprising GPRS, 3G, broadcast TV network, telecommunication network, power carrier network and satellite via the Internet.

U.S. Published Application 20150032886A1 is to be distinguished from the present Application by the following aspects:

Paragraph [0033] of this U.S. Application describes a generic interaction between terminals, grouping them according to hierarchy, making each group capable of processing public information of the monitoring units in a group of industries or industry, which comprises statistical data analysis, geographical information, secure authentication and dispatch and data management. The knowledge units are classified into different types according to categories of monitored terminals, such as air conditioner equipment, construction machinery equipment and networking industry.

As for the claims of U.S. Application 20150032886A1, they are focused on the fact that the system is a real-time monitoring system based on cloud computing, comprising a plurality of monitored terminals, a plurality of management terminals and a cloud monitoring platform, as summarized in the preceding paragraph. The focus of the published US document cited above is on the real-time platform that can be applied to air conditioner equipment, construction machinery equipment and networking industry understood in the context of the '886 Application as a kind of network equipment including servers, broadcast equipment, high capacity telecommunication network equipment and computers, for example. Different from the '886 Application, the present invention provides a system and method merging databases of a real-time remote monitoring and management system with logistics, assets control maintenance and Enterprise Resource Planning (ERP) databases so that it is possible to obtain a wide combination of high level variables. Such technological advance is not described nor suggested in the '886 Application.

Further, U.S. Published Application 20150211684A1 relates to various embodiments that provide an end-to-end gaseous fuel transportation solution without using physical pipelines. A virtual pipeline system and methods thereof may involve transportation of gaseous fuels including compressed natural gas (CNG), liquefied natural gas (LNG), and/or adsorbed natural gas (ANG). An exemplary pipeline system may include a gas supply station, a mother station for treating gaseous fuels from the gas supply station, a mobile transport system for receiving and transporting the gaseous fuels, and a user site for unloading the gaseous fuels from the mobile transport system. The unloaded gaseous fuels can be further used or distributed.

Published US Application 20150211684A1 concentrates its description on procedures that involve compression, transportation and distribution of gaseous fuels for different applications. Most of its contents are in the public domain, introducing the main company's practices used for virtual pipeline compressed natural gas distribution. It is mentioned that compression, transportation and decompression/delivery points can be instrumented to facilitate operation under different aspects such as control, operational procedures and problem diagnosis. There are no details referring to a more detailed form of instrumentation used, procedures for data collecting and storage or information crossing for decision taking. At paragraph [0100] there is a hint on technologies that could possibly be used for data communication, as well as some variables that could be monitored such as pressure and temperature.

As long as in Published Application CN106127430 a logistics system based on a power company where the information provided by the vehicle-mounted devices, like environmental variables, real-time truck position and RFID goods identification, are the main way of analyzing and controlling the provided service, in the present application this type of information represent just a part of the whole variable group involved in the CNG transport productive chain. Those variables are distributed in individual databases according to their source and characteristics. However, the system disclosed in CN106127430 does not correlate the information acquired, in order to provide a managing decision in real-time. Thus, CN106127430 fails to provide data correlations, which will compose the indicators claimed by the present application and not such variables themselves.

As an example, while in CN106127430 a control room sends a request in order to identify the goods transported, the environmental conditions and the real-time truck position, the present application acquires information of this nature but correlate them to others, originated from the management, logistics, inventory and assets control systems, to compose indicators and act on the whole CNG transport process.

Those correlations make explicit relevant particular data about CNG transport process, contrasting with CN106127430, wherein the claim focus is the transported goods traceability and Internet of Things (IOT) use. Examples of correlation that allow the process optimization are: Trailer and delivery point efficiency rate, delivered volume versus budget, energy consumption by loaded volume.

Cloud database procedures are public domain technologies, regardless of the data consumer application. Those procedures are not being claimed.

In Published Application CN 106096898 a RFID scanning-based truck monitoring system is disclosed, where the vehicle instrumentation, like RFID tags, environmental variables measuring and the monitoring cameras, allow the trucks' on-board and external control and monitoring. In reason of goods sensibility this control is necessary. The CN106096898 is directed to the instrumentation, which allows the claimed system to track good's quality during transport. Thus, CN106096898 also fails to provide data correlations, which will compose the indicators claimed by the present application and not such variables themselves.

None of the embedded communication technologies (Bluetooth, Wi-fi, RFID, CAN) and environmental control variables used in CN106096898 are the object of protection of the present application; some of these technologies are just a form of data acquisition for the present application. The present Application explore the data correlations, generating indicators that will support the operation of a CNG distribution system.

The Published Application CN106897843 relates to a waste oil recovery dispatching and storage and transportation system based on the internet of things and cloud computing generating indicators based-in data crossing, limited to oil amount accumulated by generator unities and recycling unities.

The triggers sent to the tank-oil trucks for collecting oil process, according to the presented in CN106897843, are based in the nearness and measured oil amounts in the tanks. Thus, CN106897843 only correlates location and oil volume information, in order to optimize time and collecting route. The present application schedule system is fed by several variables information and not just by amount and location information, as presented in CN106897843. As an example, in present application, it is possible to cross loading lanes status and CNG compressors availability, integrating telemetry and maintenance information, priority levels and connected customers autonomy forecast to make the CNG transportation's trailers schedule. The present application claimed indicators that have as common feature the process efficiency rate representation and several different nature variables crossing, not just cumulative nature indicators by unity like in CN106897843.

The systems disclosed in the state of the art do not provide correlations among the several variables involved in the transport and delivering of compressed gaseous fuels on wheels, in order to provide accurate managing indicators for a decision in real-time.

Although the present Application is also directed to distribution of compressed gaseous fuels on wheels, it innovates by providing a method merging real-time telemetry with logistics, assets control maintenance and Enterprise Resource Planning (ERP) databases in a way that it is possible to organize system levels and how data is entered into the system.

Additionally, the present Application creates a real-time unified database and system interactions based on information crossing from the said databases including telemetry, logistics, maintenance and ERP. The architecture of the system is such that at the base of the system there are the variables from each database, then variables from all databases are merged, making it possible to cross information in real-time and thus creating high level variables, that according to a logic defined into the system will crosscheck the values of these variables allowing or not a certain operation. Such technological advance is not described nor suggested in the '684 Application.

The purpose of the present invention is to present a method and system and all necessary resources for real-time monitoring and management of compressed gaseous fuel operation and distribution from a gas supply from a pipeline by merging physical, logistics and maintenance parameters for operation control. To achieve high-levels of interpretation and presentation, it makes use of different resources such as a control room and a managing dashboard, that includes a set of operation variables and managing KPIs that are explained in the detailed description section.

### SUMMARY OF THE INVENTION

In accordance with the invention, there is presented a method and system to operate and distribute compressed gaseous fuel from a gas supply from a pipeline such as LNG (Liquid Natural Gas). Adsorbed Natural Gas (ANG) or compressed natural gas (CNG) on wheels. Since the Applicant business is specially directed to CNG the Application is specially directed to this field, however, it should be borne in mind that it applies as well to any kind of gaseous fuel from a pipeline, which should be compressed, transported and delivered to the final customer.

According to the invention, the method for remote real-time monitoring and management of compressed gaseous fuels distribution on wheels comprises the following steps:
a) automating the loading process of the trailer(s) carrying the compressed gaseous fuels on wheels by providing instrumentation to: i) at least one compression station CS; ii) trailer(s) and iii) Delivery Point(s) DP, all the said trailer(s) being monitored in real-time by at least one control room;
b) based on the instrumentation provided to a), receiving in real-time telemetry information at a telemetry database from the loading equipment of at least one of the CS, from trailer(s) traveling during displacement, and from the unloading equipment of at least one of Delivery Point(s) DP, wherein said telemetry data are processed by an application and then the processed telemetry data return as operation guidelines to the at least one CS, trailer(s) and Delivery Point(s) DP as automation commands and to the at least one Control Room as low-level variables for decision taking;
c) storing the telemetry information received at b) in said telemetry database

DB and uploading same in real-time to a cloud database supplied for redundancy reasons with at least two servers that can run the application, and returning processed telemetry information to the telemetry DB as low-level variables for decision taking;
d) Providing a logistics database, storing logistics information received from said logistics database DB and uploading same in real-time to the same cloud database of c), then returning processed logistics information to the said at least one Control Room as high-level variables for decision taking;
e) Providing a maintenance database, storing maintenance information received from said maintenance DB software platform and uploading same in real-time to the same cloud database of c) then returning processed maintenance information to the said at least one Control Room as high-level variables for decision taking return;
f) Providing an ERP database, storing ERP information received from the said ERP database and uploading same in real-time to the same cloud database of c), the combination of the c), d), e) and f) databases forming a united, standardized information for information crossing and backing-up then returning processed ERP information to the said at least one Control Room as high-level variables for decision taking;
g) Based on the low- and high-level variables obtained at steps b) c), d), e) and f), information crossing and backing up in real-time to create high-level variables, the values of said variables being cross-checked by a logic defined in the system allowing or not a certain operation, an application stored and run in the cloud database showing the interface level to the said at least one control room—to operate the system—and to the managing dashboard—to manage the system based on statistics and KPI's and receiving return information from the said at least one control room; and
h) managing the dashboard to convey commands to said at least one CS, trailer(s) and Delivery Point(s) DP.

And the system of the invention for remote real-time monitoring and management of compressed gaseous fuels distribution on wheels from at least one Central Station CS to Delivery Point(s) DP through several Routes using Trailer(s) loaded with said compressed gaseous fuel comprises:
a) telemetry, maintenance, logistics and ERP databases that provide low-level variables from the at least one CS, Delivery Point(s) DP and trailer(s) loaded with compressed gaseous fuel to at least two servers in the cloud, one of which being a back-up server;
b) the at least two cloud servers of a) providing: i) data to a dashboard comprising a computer, a tablet or a smart phone; ii) data to control room(s), said control room(s) also providing data to the said at least two servers; and
c) a logic defined into said system, said logic, by crossing information in real-time, providing for the crosschecking of the values of the high-level variables obtained from the merging of low-level variables obtained from said telemetry, maintenance, logistics and ERP databases, said crosschecking making it possible to present said high-level variables as customized variables controlled by Control Room and managing level users, said users being able to make use of said correlations and or of existing variables and even add new variable combinations.

These and other aspects of the various embodiments of the present invention, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various Figures.

### BRIEF DESCRIPTION OF THE DRAWINGS

FIG. 1 is a scheme representing the pipeline, compression station CS, delivery points DPs, routes and the coverage radius for compressed gaseous fuel distribution on wheels.

FIG. 2 shows the operation model based on instrumentation of the compression station CS, trailers and delivery point(s) (DP), monitored in real-time by a control room that receives information from the instrumentation enabling operation monitoring/management and control.

FIG. 3 is a scheme depicting the operation model of the invention based on the at least one compression station CS, trailer(s) and delivery point(s) (DP) instrumentation monitored/managed in real-time by a at least one control room, serving nine delivery points and using eight routes.

FIG. 4 shows the system's database DB structure and how the system parts interact.

FIG. 5 shows schematically the system levels and how data entry into the system can be processed, including the way other databases DB are stored and cross-checked to generate information for operation and management.

FIG. 6 shows the operation variables from telemetry, logistics and maintenance databases DB that generate the compression station, travel/displacement and delivery point variables.

FIG. 7 is a scheme of the operation variables from telemetry, logistics, maintenance and ERP databases that generate safety, logistics, operation and maintenance variables as well as progress control variables for managing dashboard KPIs.

FIG. 8 depicts real-time monitoring and management system layers, showing layers that have a direct relationship with the managing dashboard (management layer) and control room operation (logistics). Also shown, operation variables composition (operation and maintenance layer) and the whole system regarding programming, expansion and system maintenance (engineering layer).

### DETAILED DESCRIPTION OF THE INVENTION

From the present specification and claims it should be clear to the experts that the present method and system for remote real-time monitoring and management of compressed gaseous fuels on wheels is to be used for end-to-end gaseous fuel transportation without using physical pipelines but using a mobile transport system, for example. As used herein, gaseous fuel encompasses both fuel that is in a pure gas phase, as well as fuel that includes both gas phase and liquid phase components (e.g., mixed natural gas that includes gas phase components (e.g., C₅ and under components such as methane, ethane, propane, butane), as well as components that may be liquid at ambient temperature and pressure (e.g., hexane, octane, etc.)).

In one or more embodiments, the end-to-end gaseous fuel transportation may include gaseous fuel transportation, for example, between a gaseous fuel supply station (e.g., a supply pipeline or hub, a flare gas capture station, a gas-producing well, etc.) and an end user/customer; between a gaseous fuel supply station and a gaseous fuel distribution station, e.g., for further gaseous fuel dispensing to other end users or another gaseous fuel distribution station, etc.; and/or between a wellhead and a gathering point (e.g., a supply pipeline, LNG facility, etc.).

In the specific example described below in the present specification, the compressed gaseous fuel is natural gas. The principle of natural gas distribution on wheels starts with either construction or availability of at least one compression station CS, not too far from the delivery point(s) DP not served by a pipeline but which are to be supplied with natural gas or any other gaseous fuel.

The system and method of the present invention will now be described by reference to the appended Figures, which should not be construed as limiting the scope of the invention.

A logic defined into said system, said logic, by crossing information in real-time, providing for the crosschecking of the values of the high-level variables obtained from the merging of low-level variables obtained from said telemetry, maintenance, logistics and ERP databases, said crosschecking making it possible to present said high-level variables as customized variables controlled by Control Room and managing level users, said users being able to make use of said correlations and or of existing variables and even add new variable combinations.

The logic's applications use databases for crosschecking information, for providing control room operation tables as well as a variety of configurable screens designed to exhibit information related to said high-level variables.

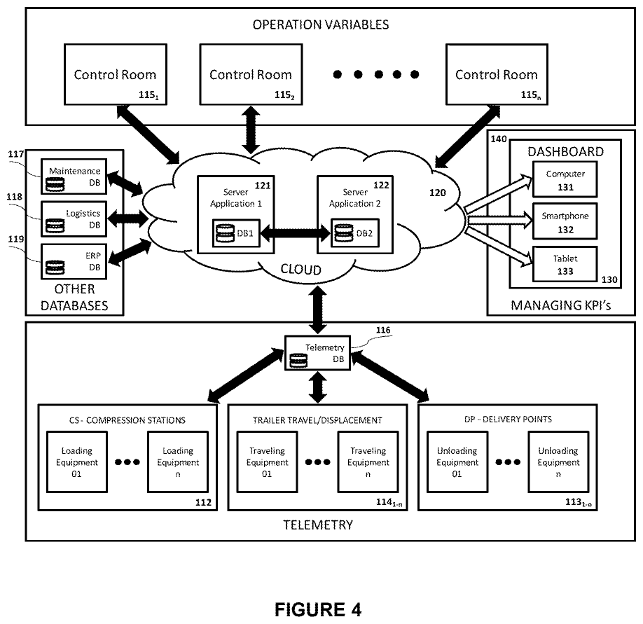

The system which is one of the objects of the invention is generally designed by numeral 100 chiefly in FIGS. 4, 5 and 8 appended herein.

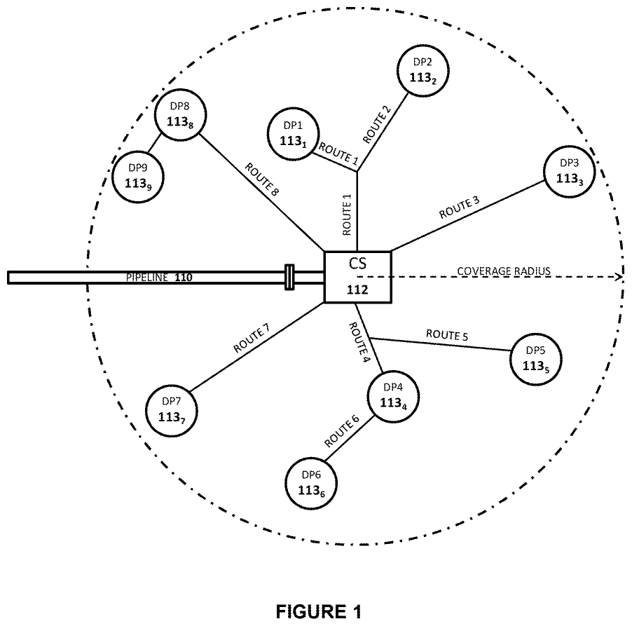

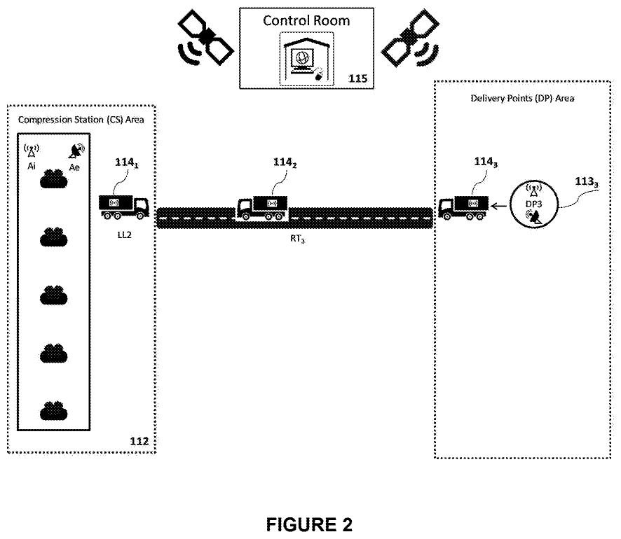

FIG. 1 shows a scheme representing a pipeline 110, a compression station CS 112, delivery points DP 113, routes RT₁₋₈ and the coverage radius for a natural gas distribution on wheels. As can be seen in FIG. 1, pipeline 110 arrives at compression station CS 112, where trailers 114₁₋ₙ (n being up to an unlimited number) will be loaded, as seen in FIG. 2.

A trailer (not represented in FIG. 1) carries out the compressed gaseous fuel transportation from CS 112 to any Delivery Point DP 113₁₋ₙ (n being up to an unlimited number), returning to CS 112 for reloading. The trailer makes use of different routes RT₁₋₈ to arrive at different DPs 113. In the Example shown in FIG. 1, nine DPs 113 using eight routes RT₁₋₈ are partially shared by seven DPs 113 (DP 113₁ and DP 113₂, DP 113₄ and DP 113₅ and DP 113₆, DP 113₈ and DP 113₉).

Each DP 113₁₋ₙ is at a different distance from CS 112, and for each one, a trailer 114 is loaded at compression station CS 112 and carries out unloading at a different DP 113. The displacement time from CS 112 to each DP 113 is different, due to distance and traffic conditions. Also, is the compressed gaseous fuel or natural gas consumption, due to each DP 113₁₋ₙ's profile.

The frequency a trailer 114₁₋ₙ must be unloaded at each DP 113₁₋ₙ is different, as well as is the consumption of each DP 113₁₋ₙ. The loading capacity of the compression station CS 112 is a function of the peak hour demand of all DP 113₁₋ₙ.

The complexity of the operation increases with the increasing number of DP 113₁₋ₙ, passing through peaks and valleys of consumption during days, seasons besides other peculiarities.

To keep the operation running, the use of instrumentation and real-time communication among CS 112, trailers 114₁₋ₙ on the road and DPS 113₁₋ₙ is mandatory.

### Operation Model

FIG. 1 shows the fuel distribution system covering of this invention.

FIG. 2 shows the operation model based on instrumentation of compression station CS 112, trailers 114₁₋ₙ and delivery points DP 113₁₋ₙ, monitored/managed in real-time by a control room 115 receiving information from the instrumentation enabling operation monitoring/management and control.

FIG. 2 depicts the compression station CS 112 area, loading lane 2 (LL₂) with a trailer 114₁₋ₙ being loaded, route RT₃ with a trailer 114₁₋ₙ returning to CS 112 and DP 113₃ with a trailer 114₁₋ₙ being unloaded. In total for DP 113₃, there are three trailers 114₁₋₃ serving it 24/7.

As can be seen in FIG. 2 at CS 112 and DP 113₁₋ₙ, two kinds of antennas A communicate with a trailer 114₁₋ₙ. The tower antenna symbol Ai represents internal communication inside the site whereas the dish antenna Ae represents external communication between CS 112 or DP 113 with the system cloud. The antenna symbol on a trailer 114₁₋ₙ means that it is instrumented with an electronic tag (RFID), with wireless pressure and temperature transmitters and a GPS.

FIG. 2 shows a compression station 112. There's at least, near to the access gate, one UHF RFID antenna 200. These antennas collect the trailer ID, by means of RFID tags attached to it, and the timestamp at the moment when the trailer pass through them. When the trailer enters in a loading lane LLn, the RFID antenna 201n sends trailer's entering timestamp to the telemetry database 116. When the loading process starts and when the trailer 114n leaves the LLn, either because it's totally charged or by another reasons, the same pieces of information are collected. The trailer 114n loading time can be calculated by the difference between the collected timestamps.

In the CS 112 there are, also, pressure and temperature transmitters, mass flow meters and valve positioning sensors, that identifies if the valves are open or closed. The analogic and digital information from those instruments are locally processed by a PLC. These processed data blocks are sent to the telemetry database 116 by an external antenna Ae and a GPRS or Ethernet modem and can be shown in the control room 115.

Besides the RFID tag attached to the trailer there's a geolocation device that collects the latitude and longitude coordinates while the trailer is traveling between a compression station CS 112n and a delivery point DP 113n. Those blocks of data are also sent to the telemetry database 116 y can be accessed by the control room.

As in the compression stations 112n, there are, in the delivery points DP 113n, where the CNG is unloaded from the trailers, a RFID antenna 202, that collects the truck's ID and entering and leaving timestamps. In the DPs there are, also, the same measurement instruments of the compression station 112n. These blocks of data are also sent to the telemetry database and can be accessed by the control room.

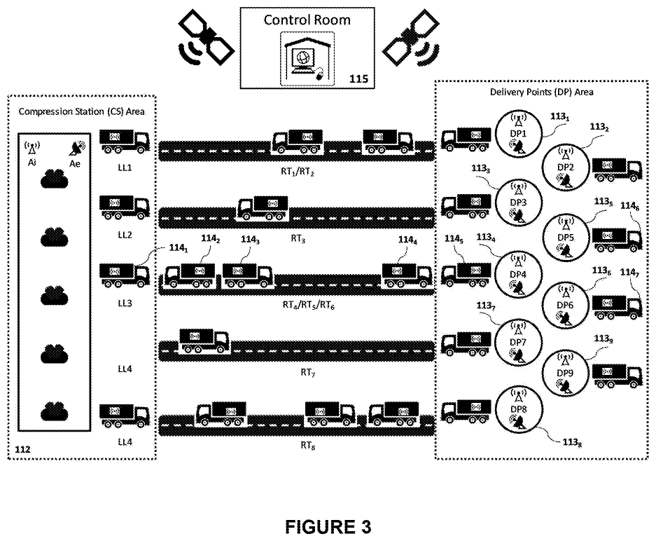

Following the example presented in FIG. 2, FIG. 3 shows a complete CS 112, serving nine DPs 113₁₋₉, using eight routes RTs₁₋₈. This represents the same configuration as shown in FIG. 1 where there is a CS 112. and the interaction with DPs 113₁₋ₙ. Here the loading lanes LL are occupied at the compression station 112 serving different DPs 113 and not necessarily the same LL is constantly serving the same DP. The LL used to load a trailer 114₁₋ₙ changes according to the demand, and the specific trailer 114 is usually loaded at the first available lane, according to the unloading priority at DP 113₁₋ₙ. This is done following the guidelines of the delivery point priority panel presented in Table 3 of the present Application.

The Applicant has also considered that at each DP 113₁₋ₙ there are, at least, two unloading lanes UL that can be swapped, assuring continuous compressed gaseous fuel supply. FIG. 1 also shows trailers 114₁₋ₙ that supply the DP 113₁₋ₙ, considering that some trailers 114₁₋ₙ unload at different DP 113₁₋ₙ on some routes RT and have their paths shared up to a certain displacement point (see FIG. 1 for comparison), like DP 113₁ and DP 113₂, DP 113₄ and DP 113₅ and DP 113₆, DP 113₈ and DP 113₉.

The unloading at a certain DP 113₁₋ₙ is currently carried out by specific trailers 114₁₋ₙ, for example: on routes RT₄/RT₅/RT₆ there are seven trailers 114₁₋₇ doing the delivery: two trailers 114₁₋₂ for DP 113₄, three trailers 114₃₋₆ for DP 113₅ and two trailers 114₆₋₇ for DP 113₆.

The current operation shown in FIG. 3 starts with the identification/recognition of trailers 114₁₋ₙ using radio frequency identifiers (RFID), which store information related to the characteristics of the equipment, including model, preferred customer, planned maintenance, usage rate, among others. These, along with the CS 112 instrumentation, pressure, temperature, flowrate and volume data, enable automating the loading process.

Displacement times from CS 112 to DP 113₁₋ₙ and from DP 113₁₋ₙ to CS 112 are monitored/managed and evaluated in real-time to perform the dynamic adjustment of the logistics, since each trailer 114₁₋ₙ is equipped with a global positioning system (GPS) and transmits its position when passing through a determined check-point (not represented).

On the DP 113₁₋ₙ side, to which the final customers are connected, trailer 114₁₋ₙ identification/recognition is also installed using radio frequency identifiers (RFID), these being integrated to other variables such as consumed volume, flow rate, pressure, temperature, and other ones.

For each CS 112, trailer 114₁₋ₙ, and DP 113₁₋ₙ there is a set of parameters that are transmitted, stored and processed, all of them being monitored/managed by control room 115.

CS 112 and DP 113₁₋ₙ convey to the telemetry DB 116 information regarding engineering parameters such as pressure, temperature, flow rate, volume and a great variety of status variables of the entire compression and decompression/delivery processes. The main variables, which have a direct influence on the operation process, are addressed in detail in FIG. 3 and further in FIG. 4.

FIG. 3 depicts, for the sake of illustration only, and without limiting the invention, the operation model based on instrumentation of at least one compression station CS 112, trailers 114₁₋ₙ and delivery point(s) DP 113₁₋ₙ, monitored in real-time by a control room 115, serving nine delivery points DP 113₁₋₉, using eight routes RT₁₋₈.

### Database Structure

FIG. 4 shows the system's 100 database structure and how the system 100 parts interact. As can be seen, system 100 is receiving telemetry information at telemetry DB 116 from loading equipment at the at least one CS 112, from trailer(s) 114₁₋ₙ traveling during displacement, and from equipment unloading at DP 113₁₋ₙ. All this information is stored in said telemetry database 116 and uploaded in real-time to a cloud database 120 with at least two DB servers 121, 122 able to run the application stored therein. While only one server 121 or 122 of the at least two servers would be able to do the job, the Applicant considers that providing at least two servers 121, 122 for redundancy reasons bring more security to the entire process.

The telemetry database 116 is fed by collected information from: (i) compression stations (112n), the first block of data, (ii) delivery points (113n), the second one, (iii) the geographical coordinates collected, while the trailers are traveling, the third one. The bidirectional interface between 116 and the equipments installed in 112n and 113n is established by a communication modem. These modems send the data through a GPRS, ADSL or optical fiber connection.

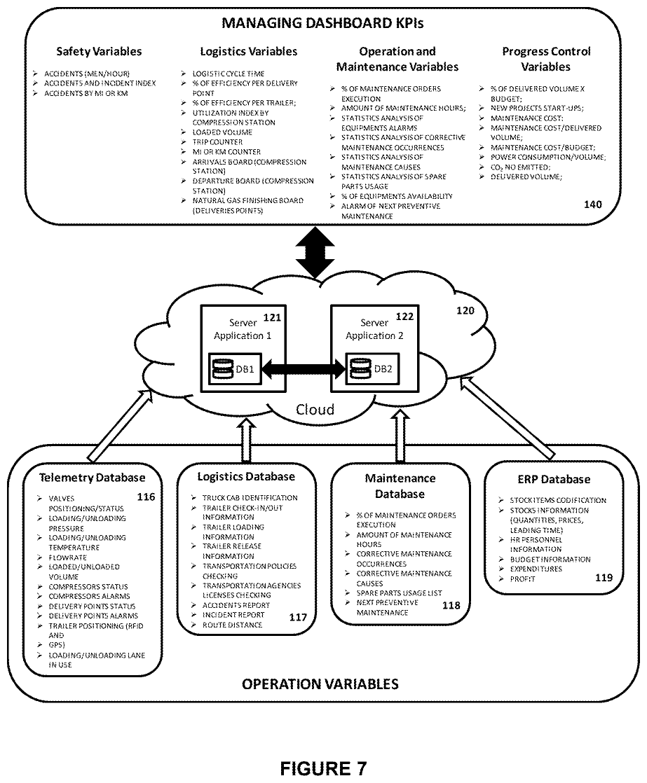

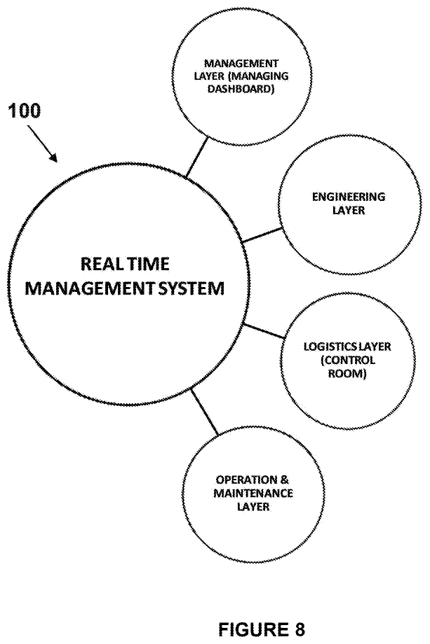

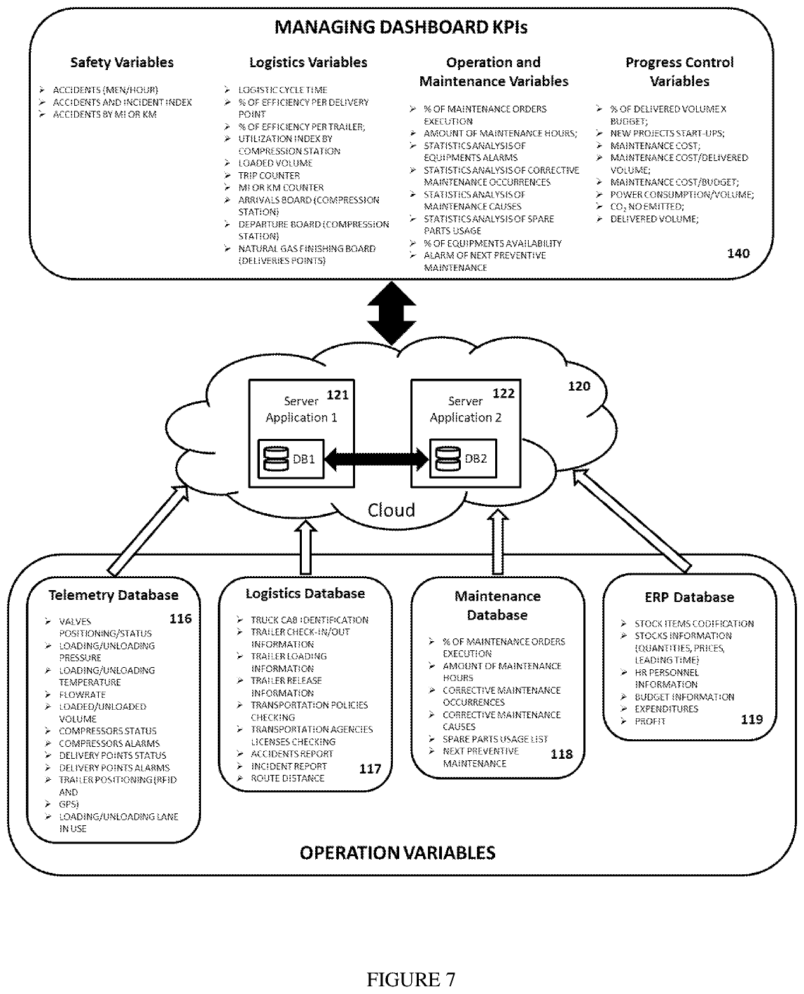

The databases 117, 118, 119 are fed by electronic devices, PCs, smartphones and tablets. In the FIG. 7 are shown some kind of information that composes the other blocks of data. These blocks of data are the fourth, fifth and sixth ones.

The telemetry database 116, 117, 118 and 119 feed the main application's hoster database located in the cloud 120 (main and back-up), through a data connection. The data flow in the bases 120 are bidirectional with the control room (115n), where the pieces of information resulting from the process are shown and new ones can be added through human interaction. The blocks are continually, with a settable time interval, sent to the database. There's an update option that allows to the system operator to send the data blocks at the moment of button pressing.

According to FIG. 4, system 100 interacts with other databases, telemetry DB 116, maintenance DB 117, logistics DB 118 and ERP DB 119.

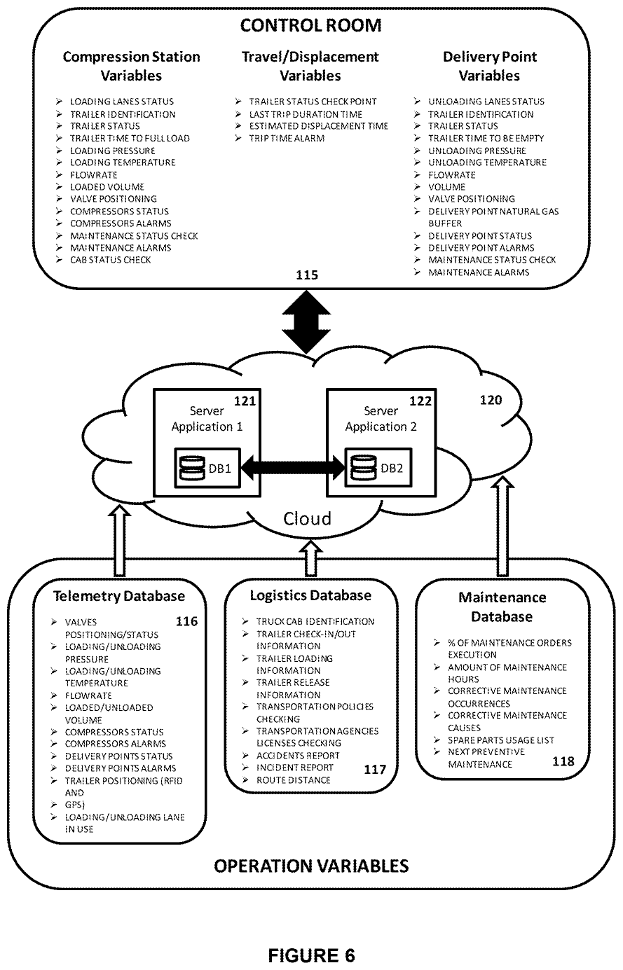

At the top of the Figure are located control room 115 or control rooms 115₁, 115₂ etc., the additional control rooms being provided as needed to operation size, where all operation variables are presented to users to manage the operation. A significant part of the information presented to control room 115 has origin in cross-checked information from telemetry 116, maintenance 117, logistics 118 and ERP 119 databases. Said cross-checked information is the first level of cross-checked variables, or low-level variables. These variables are listed at the bottom of FIGS. 6 and 7. Low-level variables can be combined, providing higher level information or high-level variables, as seen throughout the present specification.

Still in FIG. 4, as a second level of cross-checked database is the system 100 dashboard 130 intended to provide access to the whole operation of monitoring/management, based on KPIs 140 and accessed either from a computer 131, smart phone 132, or tablet 133.

In FIG. 4, the full-black painted double arrows show the flow of information/parameters, demonstrating writing and reading possibilities to and from both sides, whereas the white painted single arrow indicates the possibility of data access.

### System Levels

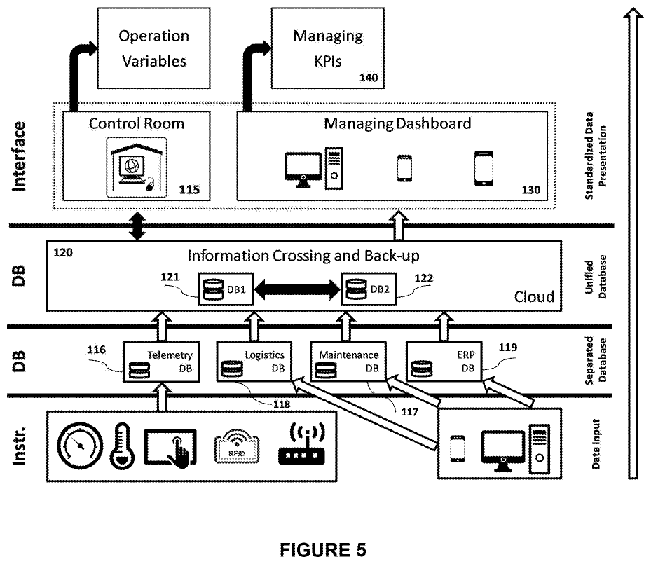

FIG. 5 shows compression station 112, delivery points 113, trailers 114 and devices. These devices can be identifiers, like the RFID antennas 200, 201 and 202, digital and analogical sensors to measure quantities like temperature, pressure, mass flow and valves status besides device geolocation. Those data compose the first, second and third data blocks, sent by CS 112n, trailer 114n and DP 113n, respectively, to the telemetry database 116.

Through the storage data in the 116, 117, 118 and 119 databases the variables and KPIs showed in the control room 115 and other devices 130, like HMI and cellphones, are generated. Those data feed, also, the cloud storage databases 121 and 122, that are aggregated in 120. In 120, besides the data storage from another bases, the correlation is stored also.

The collected information and the generated pieces of information in 120 are showed in the control room 115n and in the interface devices 130. In the first interface 115n the bidirectional communication is allowed while in the second interface 130 there's just a one way communication because they are management interfaces where just information viewing is allowed.

FIG. 5 shows the system 100 levels and how data entry into system 100 can be processed, including the way other databases are provided by the instrumentation level, being stored and cross-checked to generate information for operation and monitoring/management.

In a first step, information is stored in separated databases as low-level variables, then in a second step a unified database is developed (created) to back-up and cross-check information. The result of cross-check information/variables generate the high-level variables. Finally, in a third step standardized data is presented using different interfaces for control and monitoring/management as high-level variables.

To provide information to the first step, the instrumentation level is where data is acquired by instruments installed at the at least one compression stations CS 112, trailers) 114₁₋ₙ and delivery point(s) DP 113₁₋ₙ and information is stored at the telemetry database 116. It is also where the data is entered by HMI (human machine interface), computers 131, smartphone(s) 132, tablet(s) 133 to be stored in maintenance 117, logistics 118 and ERP 119 databases.

The first database level is where each part of system 100 stores collected information.

The telemetry database 116 is where information is stored regarding process variables as physical quantities of the process that have origin in the at least one compression station CS 112, trailer(s) 114₁₋ₙ and delivery point(s) DP 113₁₋ₙ. The variables stored are: Valves positioning/status; Loading/Unloading Pressure; Loading/Unloading Temperature; Flowrate; Loaded/Unloaded volume; Compressors status; Compressors alarms; Delivery point(s) 113₁₋ₙ status; Delivery point(s) 113₁₋ₙ alarms; Trailer(s) 114₁₋ₙ positioning (RFID and GPS); and Loading/Unloading Lane in use.

Still in FIG. 5, the logistics database 118 is where information is stored from data entered by the operator at the at least one compression station 112, for example, the driver responsible for trailer 114₁₋ₙ transportation, scanned by the trailer driver identification card, trailer 114₁₋ₙ destination and parameters that allow the operation of the asset. In other words, the logistics database 118 is where all logistics information is stored. As far as the interaction of the logistics database 118 with other databases is concerned, the most relevant stored information is: Trailer(s) 114₁₋ₙ driver identification; Trailer(s) 114₁₋ₙ check-in information; Trailer(s) 114₁₋ₙ loading information; Trailer(s) 114₁₋ₙ release information; Transportation policies check; Transportation agency licenses check; Accidents report; Incident report; and route distance.

The maintenance database 117 is where information is stored regarding all asset maintenance process, such as periodic, preventive and corrective maintenance, including instrumentation calibration data, maintenance procedures, and records. As far as the interaction of the maintenance database 117 with other databases is concerned, the most relevant stored information is: % of maintenance orders execution; Amount of maintenance hours; Corrective maintenance occurrences; Corrective maintenance causes; Spare parts usage list; and Next preventive maintenance.

The ERP (Enterprise Resource Planning) database 119 is where all essential information to run the business is stored, including inventory and order management, accounting, human resources, customer relationship management (CRM), and the like. As far as the interaction of the ERP database 119 with other databases is concerned, the most relevant stored information is: Stock items codification; Stock information (quantities, prices, leading time); HR personnel information; Budget information; Expenditures and Profit.

The second database level depicted in FIG. 5 comprises all parameters and information having origin in telemetry 116, maintenance 117, logistics 118, and ERP 119 databases stored together, opening the possibility for database correlations. The second database level is stored in at least two servers 121, 122 with a hot standby. The same at least two servers 121, 122 that store the databases also run the application that shows the interface to control room 115 and managing dashboard 130.

The purpose of the second database level is to provide cross-checked information among the physical quantities read by the telemetry 116 database with databases from maintenance 117, logistics 118 and ERP 119, generating standardized information for the interface level. This cross-checked information is the first level of cross-checked variables, or low-level variables. These variables are listed at the bottom of FIGS. 6 and 7. Low-level variables can be combined, providing higher level information or high-level variables.

The interface level is where the system 100 is operated by the control room 115 and monitored by the managing dashboard 130. For control room 115 operation, system 100 relies on a set of operation variables presented in FIG. 6.

FIG. 6 shows the 114 trailers' geolocation coordinates storage. These data are stored in the telemetry database 116. Latitude and longitude can be obtained by a GPS module, attached to the trailer, or through a smartphone app that collects the GPS from the embedded module periodically.

The set of operation variables that generates the managing KPIs 140 is presented in FIG. 7. Operation variables were discussed above in the present specification, and FIGS. 6 and 7 show the correlations among such variables to generate high-level information/variables for control and monitoring/management. To derive such correlations, at the bottom of the system are located the variables of the telemetry 116, maintenance 117, logistics 118 and ERP 119 databases, followed by the merging of all databases, enabling real-time information crossing, which in turn creates high-level variables. The high-level variables according to a logic defined into the system will crosscheck the values of the created high-level variables allowing or not a certain operation.

According to the invention, automatic commands can be generated from the KPI's generated by general variables cross-checking. Loading process, for example, in the loading lanes, is controlled by the result of the relationship among all variables from 116, 117 and 118, so the temperature control, flow, pressure and valve control are automatic controlled by the system and by the method of this invention

### Database and System Interactions

FIG. 6 shows the operation variables from telemetry 116, maintenance 117 and logistics 118 databases that generate the at least one compression station CS 112 variables, travel/displacement variables and delivery point(s) DP 113₁₋ₙ variables. As can be seen at the bottom of the Figure, the operation variables generate part of the variables that are at the top of the Figure in use at control room 115.

Some variables, at the top of the Figure, are the same as those of the bottom because there is no interaction with other variables from other databases to be generated. On the other hand, some are dependent variables as in the Example below.

The invention will now be illustrated by the following Examples, which should not be construed as limiting the invention.

### Example 1

In this Example, if it is desired to generate the information for the Loading Lane Status at the compression station 112 variables, the system cross-checks the information from Valves Positioning/Status+Loading Pressure+Loading Temperature+Flowrate+Trailer 114₁₋ₙ Check-In/Out Information+Trailer 114₁₋ₙ Loading Information+Loading/Unloading Lane In Use.

For any other compression station 112 variables, such as travel/displacement variables or delivery point 113₁₋ₙ, system 100 cross-checks more than one information to double check what is being done with the asset during loading, transportation or unloading.

### Example 2

This Example refers to traveling/displacement variables, such as Trailer Status Checkpoint, the system cross-checks the following information: Trailer Positioning (RFID and GPS)+Trailer Check-In/Out Information+Loading/Unloading Lane In Use+Trailer Loading Information+Trailer Release Information.

### Example 3

This Example also refers to the use of delivery point 113₁₋ₙ variables, such as Trailer 114₁₋ₙ Time To Be Empty. To this end, system 100 cross-checks the following information: Time+Valves Positioning/Status+Unloading Pressure+Unloading Temperature+Flowrate+Unloaded Volume.

FIG. 7 shows the same principle of FIG. 6, but for managing KPIs 140 dashboard 130. Operation variables from telemetry 116, maintenance 117, logistics 118 and ERP 119 databases (bottom of the Figure) generate the KPIs 140 variables (top of the Figure). The KPIs 140 variables are divided in four groups related to safety, logistics, operation and maintenance and progress control.

### Example 4

This Example illustrates how some KPIs 140 (Key Performance Indicators) variables are composed for each KPIs 140 group (Safety, Logistics, Operation and Maintenance and Progress Control).

Thus, Accidents By Mile Or Km=Time+Trailer Positioning (RFID and GPS)+Trailer 114₁₋ₙ Check-In/Out Information+Accidents Report. Logistics Cycle Time=Time+Trailer 114₁₋ₙ Positioning (RFID and GPS)+Trailer 114₁₋ₙ Check-In/Out Information+Trailer 114 Loading Information+Trailer 114₁₋ₙ Release Information. % Of Equipment Availability (For DP 113₁₋ₙ)=Time+Unloaded Volume+Delivery Points 113₁₋ₙ Status+Delivery Points 113₁₋ₙ Alarms+Corrective Maintenance Occurrences. Power Consumption/Volume=Loaded Volume+Compressors Status+Expenditures.

### Example 5

In this Example, Power Consumption Per Volume, where expenditure information was used, it is important to explain that the variable Expenditure has more than one dimension, having information regarding kWh consumption and the amount of money spent on power, meaning that this variable can have subclasses or dimensions.

The use of dimensions or subclasses inside the database is linked to the necessity to store more than one piece of information in the group variable. Other operation variables can have subclasses, and they can increase or decrease, according to necessity, to facilitate managing determination.

### User Platforms and Layers

The operational management system is an all-out system that integrates equipment control, logistics analysis, and maintenance information. It aims at the distribution of information over different layers in a systematic, dynamic and objective way, enabling real-time and historical analysis.

The main goal is to provide consolidated information, to meet the needs of different user profiles, the information provided being endowed with availability, safety, and agility.

The system access is divided into different platforms, to deliver the best access tool to each user. The system platforms are:

WEB platform, intended for the management system and engineering only, with simultaneous and unlimited inquiry accesses;

A proprietary platform with simultaneous accesses, intended for use in control rooms and via web, being distributed in licenses for operation and visualization only;

A mobile platform for access via smart phone or Tablet with simultaneous accesses to the platform, with availability for different operational systems like Android, iOS and Windows Phone.

It should be noted that the system provides for automatic switch-off after 5 minutes without user interaction with the screen (time editable by engineering layer users only).

The use of the access platform for each individual user enables the system to be separated into layers related to Management, Engineering, Logistics and Operation and Maintenance.

FIG. 8 illustrates system 100 layers that have a direct relationship with managing dashboard 130 (management layer) and control room 115 operation (logistics). Two other layers are shown in FIG. 8: one of the layers has an influence on the operation variables composition (operation and maintenance layer) while the other layer is related to engineering, that has an impact on the whole system regarding programming.

Database variables interaction tables were discussed in item Database and System Interactions above in the present specification, since system 100 is made from four databases: telemetry 116, maintenance 117, logistics 118 and ERP 119.

A description of each layer of system 100 and its assignments is shown below.

Management Layer (Managing Dashboard): Access to this layer leads to consolidated information as shown in FIG. 7 as related to the managing dashboard 130 KPI's 140 box (top of the Figure). This layer can access the system via web platform and mobile devices connected to the Internet including smartphone(s) 132 and tablet(s) 133.

The Management layer is separated into two subdivisions, namely: Corporate, with access to all information on all operations; and regional, with limited access to projects and equipment that are part of its operation.

Engineering Layer: this layer is designed to visualize, control and manage the information on all layers and access platforms, being responsible for system 100 maintenance, development of new features, improvements, error correction, and customization.

Logistics Layer (Control Room 115): This layer has custom access to information concerning the company's equipment operation including all variables that have an influence on logistics. The same is shown in FIG. 6, inside the control room 115 box. This layer shall access information via the SCADA system (Supervisory Control and Data Acquisition) with a proprietary interface.

Operation and Maintenance Layer: the operation and maintenance layer has access to any equipment requiring real-time monitoring, as the process equipment at DPs 113, where it is possible to monitor, adjust reference values (Set Points) and remotely operate it. This layer shall access detailed information from the SCADA system in a summarized form, using a smartphone app.

### System Screens

The system screens are divided according to user platforms and layers grouped by variables area as explained and shown in previous diagrams.

Considering that the main purpose of the system 100 is to monitor/manage and control the compressed natural gas distribution based on cross-checked information from databases in real-time, the layers that are under permanent use are the logistics (control room) as well as operation and maintenance layers.

Table 1 below shows an Example of the next departures screen at compression station CS 112 as presented to the operators at control room 115. As can be seen, the Table shows two compression stations, CS 112₁ and CS 112₂. CS 112₁ has four loading lanes LL01 to LL04, and CS 112₂ has two loading lanes LL01 and LL02.

TABLE 1
NEXT DEPARTURES AT COMPRESSION STATION
DD/MM/YYYY-14:00

| COMPRESSION | LOADING | | | |
|---|---|---|---|---|
| STATION | LANE | TRAILER ID | DEPARTURE TIME | DESTINATION |
| CS01 | LL 01 | BCH 1456 | 14:28 | DP01 |
| CS01 | LL 04 | IVV 1843 | 15:47 | DP07 |
| CS01 | LL 03 | HLX 1998 | 16:22 | DP04 |
| CS02 | LL 01 | STU 4328 | 16:35 | DP08 |
| CS02 | LL 02 | ALT 1125 | 20:31 | DP09 |
| CS01 | LL 02 | EMPTY | N/A | N/A |

Thus, trailer 114 ID identifies the asset that is being loaded. The departure time column indicates when the trailer 114 is ready to depart while in the destination column the delivery point DP 113 where trailer 114 will be delivering its load is informed. On the top right corner, there is information regarding system date and current time.

To back up the availability both of compression station 112 and of each loading lane LL, database cross-check information is provided to allow or refuse loading. For example, to have the compressors released to supply compressed natural gas to a determined loading lane LL, system 100 checks the maintenance status of the asset using the maintenance database variable “next preventive maintenance”. After this check, system 100 releases the asset to be shown on the chart. The same principle is valid for the loading lane LL and delivery point DP 113.

Regarding the information “next departures” on the compression station 112 table, at CS 1121 LL02 is empty there is no trailer 114 being loaded at 14:00. The next trailer 114 arrives at 14:15 according to “next arrivals” on the compression station 112 table shown in Table 2 below.

Table 2 below shows the arrivals at CS 112, ordering the loads, optimizing trailer 114 loading order, according to delivery points' DP 113 consumption, displacement time between CS 112 and DPs 113, peak consumption, peak traffic and priority.

As can be seen, system 100 enables synchronism between departures and arrivals. The system works to optimize trailers 114 logistics, improving trailers usage for pick-up and delivery between CS 112 and DPs 113.

TABLE 2
NEXT ARRIVALS AT COMPRESSION STATION
DD/MM/YYYY-14:00

| COMPRESSION | LOADING | | ARRIVAL | |
|---|---|---|---|---|
| STATION | LANE | TRAILER ID | TIME | ORIGIN |
| CS01 | LL 02 | RJM 1983 | 14:15 | DP06 |
| CS01 | LL 01 | JMB 1986 | 14:35 | DP02 |
| CS01 | LL 04 | RAF 5608 | 16:01 | DP03 |
| CS01 | LL 03 | HBF 1610 | 16:31 | DP05 |
| CS02 | LL 01 | FFA 8823 | 19:32 | DP09 |
| CS02 | LL 02 | LCL 1973 | 15:20 | DP08 |

Table 3 below shows the delivery point DP 113 priority panel where the buffer time or time to be empty for each trailer 114 unloading at each DPs 113 is presented.

According to the peak demand of the DPs 113 process and peak traffic to arrive, a loading priority at CS 112 is defined. In addition to this information, the available buffer time and the peak consumption at DPs 113 are also considered in the calculation to set the designed loading lane LL, as well as the flow rate used to load the trailer at CS 112 to assure CNG supply to all DPs 113 without interruption.

TABLE 3
DELIVERY POINTS PRIORITY PANEL
DD/MM/YYYY-14:00

| | | NEXT | | |
|---|---|---|---|---|
| | | TRAILER | | PEAK |
| | | ARRIVAL | | DEMAND |
| DELIVERY | BUFFER | TIME | CONSUMPTION | X PEAK |
| POINT | TIME | (Estimated) | (Dekatherm/h) | TRAFFIC |
| DP01 | 4:46 | 15:35 | 35 | MEDIUM |
| DP02 | 3:21 | 14:29 | 49 | MEDIUM |
| DP03 | 4:50 | 17:25 | 38 | HIGH |
| DP04 | 5:49 | 17:50 | 31 | LOW |
| DP05 | 3:50 | 15:01 | 45 | LOW |
| DP06 | 5:01 | 16:40 | 28 | MEDIUM |
| DP07 | 6:03 | 16:55 | 23 | LOW |
| DP08 | 2:08 | 14:39 | 55 | HIGH |
| DP09 | 9:10 | 21:55 | 19 | MEDIUM |

Table 3 above depicts the Delivery point DP 113 priority panel, showing all DPs 113, buffer time in each, next trailer 114 arrival time at each DP 113, on-the-spot consumption of CNG at each DP 113 and supply priority level of each DP 113 according to peak consumption demand x peak in traffic to arrive at each DP 113.

Tables 1, 2 and 3 in fact are images of real-time screens, having different coloring and animation features such as: status bar, capacity bar (low/hi, full/empty) and others, available for each cell of the table, to make the information shown more interactive and allowing the operators take additional actions if necessary.

Regarding other screens of the system such as the process supervisory screens based on the P&ID or equipment diagram of the equipment at DP 113 and CS 112, those are at a lower system level and are shown by SCADA. They are directly related to the equipment operation. For each equipment installed at a delivery point DP 113, a new process screen shall be added to the system. On the added screen, all variables of the equipment, including alarms, process at DP 113 shall be displayed, as well as logistical information and the animation of the components status. The variables that shall be represented in each of the screens are indicated in a communication interface spreadsheet that can grow or reduce according to the need of the unloading process monitoring at DP 113.

An interactive screen with information summary for maintenance of components shall be submitted when the control room operator clicks on the maintenance tool icon at each DP 113 unloading process screen. For example, it is possible to check the ERP code of a given component that is presented to facilitate maintenance, as well as buttons to access the catalog, component maintenance handbook, and recommendations for adjustments or procedures. These buttons can be used to open documents (PDF), as well as electronic spreadsheets (Excel) or instructional videos and modification of these links in real-time, by the user with engineering's permission. (These files shall be previously stored on the server).

Just as is the case with the interaction screen for maintenance, interactive screens for adjustment of the process stages set points shall be provided as well as control devices for opening and closing valves remotely.

### Reports

System 100 includes management reports that are generated through a WEB platform and operational reports, which are generated through the SCADA system. All system 100 reports can be scheduled to be periodically (daily, weekly or monthly) sent, via email or by user command, selecting the sampling period.

The permission assigned to the user limits the types of report, avoiding undue reporting. In addition to the standard reports described below, it is possible to create dynamic reports, where the user can choose the sampling period and variables to be displayed.

Reports can be exported in PDF, CSV or XLS file formats besides printing on the printers configured on the device that is accessing the system.

Management reports available by system 100 include, but are not limited to:

### Consumption Report:

The consumption report shall be calculated by the accumulated corrected volume variable, subtracting the final value of the query by the initial value. It may be provided as an absolute value or by showing the accumulated values every hour within the selected period. The report query can be performed for one DP 113 per operation only, either by the CS 112 supplying that specific DP 113 or by operation unit. It depends whether the system is running in more than one country/operation.

The process is carried out simply selecting the DP 113 that shall be part of the report, selecting the DP 113 to have the accumulated volume of that set. The combination of possible stratifications is a function of the variables stored in the database.

Specific Examples are provided below.

### Example 6

If a DP 113n is selected at a given time range and selected the absolute value option, the report shall return the consumed/supplied value in that period for that equipment.

### Example 7

If selected a DP 113n in each time range and selected the hourly accumulated value option, the report shall return the value consumed every hour in the chosen period.

### Example 8

If an operation unit Y is selected, the absolute or hourly value (depending on selection) of all DPs 113 that are part of the selected unit should be presented. The same goes for a selection of DP 113n that is within the same operation, for instance.

NOTE: there is also the option to select total consumption of all operations for corporate management layer users, for example, that could be in different countries, for example.

### Trailer's Load Reports at Compression Stations:

Trailer's Load reports at compression stations feature each loading's date and start/end time, as well as the initial and final pressure and temperature, the trailer's identifier and loaded volume.

### User Connections Report:

All connections and disconnections performed by users at any of the platforms are recorded in the database, and through this report, it is possible to select the period and platform to be queried.

NOTE: disconnections due to inactivity shall also be recorded, or cases where the device that was performing the access has been disabled.

### Sent/Received Data Report:

It is possible to carry out a query about a traffic data report (sent and received) of each DP 113. It should be understood that such information is selectable per month only.

### Communication Failure Report:

It is possible to have a report on communication failures that occurred in the selected period with the faults totalizer and hours totalizer without communication per equipment. It is possible to consolidate failure reports per operation, to generate statistics on system availability and communication with the equipment.

### Registered Users Report:

This report contains all registered users, which operation and layer they belong to and which platforms they have access to, in addition to the type of standard reports they have the access configured.

### Charts

The charts are divided into managerial, visualized through a WEB application, and operational, visualized through the SCADA application.

For operational charts, it is possible to perform the selection of pre-defined variables presented in the Database and System Interactions section of the present specification, but that is not limited to the presented list, because the system can grow in an organic way adding new variables to an ICOM (Interface Communication) database. So, the possibility of chart combination naturally grows as time goes by.

Models are used for managerial charts, being available to the user the selection of the sampling period only (start/end date and time).

The system offers the use of several templates for variable choice according to the need of search, each of which has its maximum and minimum values defined and can be independently changed during execution.

The charts can be exported in PDF, CSV or XLS, in addition to printing by the printer used by the accessing device.

### Cloud

The database used by the system is redundant and located in two separate Data Centers, using Microsoft SQL Software or equivalent for information storage, being held for the last 12 months of operation, in addition to the monthly recording of data in an external backup, without losing or overwriting information. The Backup can be consulted by the application if necessary. Such activity shall be made under engineering layer intervention, with step by step procedure in the maintenance handbook. The system performs the reading and writing of variables in other databases such as telemetry, logistics, maintenance, ERP, as explained in the section related to Database Structure and FIG. 5.

The system operational reliability guarantees the use of the “fail-over” concept. This means the at least two servers work simultaneously: Main Server S1, and stand-by server S2, the latter as a contingency of the first. If the main server S1 fails, the stand-by server S2 comes into operation immediately, becoming the Main Server S2. After the return of the faulty server S1, S2 becomes the system back-up again.

Hot Standby servers swap can be carried out either manually for maintenance, updates and/or improvements or automatically when the server detects, through communication tests with this server that the main server is not working properly or any local failure is detected by the application.

For the sake of clarity, below is a list of operation variables as can be seen in the appended Figures.

It should be borne in mind that the system is not limited to any extent to the variables listed below, which should be construed as Examples only, the listed variables being changeable with time and learning. At first a set of variables is used, this set later undergoing improvements such as additions and changes as the user learns from the collected and scrutinized information.

### OPERATION VARIABLES

### Telemetry Database

VALVES POSITIONING/STATUS
LOADING/UNLOADING PRESSURE
LOADING/UNLOADING TEMPERATURE
FLOWRATE
LOADED/UNLOADED VOLUME
COMPRESSORS STATUS
COMPRESSORS ALARMS
DELIVERY POINTS STATUS
DELIVERY POINTS ALARMS
TRAILER POSITIONING (RFID AND
GPS)
LOADING/UNLOADING LANE IN USE

### Logistics Database

TRUCK CAB IDENTIFICATION
TRAILER CHECK-IN/OUT INFORMATION
TRAILER LOADING INFORMATION
TRAILER RELEASE INFORMATION
TRANSPORTATION POLICIES CHECKING
TRANSPORTATION AGENCIES LICENSES CHECKING
ACCIDENTS REPORT
INCIDENT REPORT
ROUTE DISTANCE

### Maintenance Database

% OF MAINTENANCE ORDERS EXECUTION
AMOUNT OF MAINTENANCE HOURS
CORRECTIVE MAINTENANCE OCCURRENCES
CORRECTIVE MAINTENANCE CAUSES
SPARE PARTS USAGE LIST
NEXT PREVENTIVE MAINTENANCE

### ERP Database

STOCK ITEMS CODIFICATION
STOCKS INFORMATION (QUANTITIES, PRICES, LEADING TIME)
HR PERSONNEL INFORMATION
BUDGET INFORMATION
EXPENDITURES
PROFIT

### Control Room

### Compression Station Variables

LOADING LANES STATUS
TRAILER IDENTIFICATION
TRAILER STATUS
TRAILER TIME TO FULL LOAD
LOADING PRESSURE
LOADING TEMPERATURE
FLOWRATE
LOADED VOLUME
VALVE POSITIONING
COMPRESSORS STATUS
COMPRESSORS ALARMS
MAINTENANCE STATUS CHECK
MAINTENANCE ALARMS
CAB STATUS CHECK

### Travel/Displacement Variables

TRAILER STATUS CHECK POINT
LAST TRIP DURATION TIME
ESTIMATED DISPLACEMENT TIME
TRIP TIME ALARM

### Delivery Point Variables

UNLOADING LANES STATUS
TRAILER IDENTIFICATION
TRAILER STATUS
TRAILER TIME TO BE EMPTY
UNLOADING PRESSURE
UNLOADING TEMPERATURE
FLOWRATE
VOLUME
VALVE POSITIONING
DELIVERY POINT NATURAL GAS BUFFER
DELIVERY POINT STATUS
DELIVERY POINT ALARMS
MAINTENANCE STATUS CHECK
MAINTENANCE ALARMS

### MANAGING DASHBOARD KPIs

### Safety Variables

ACCIDENTS (MEN/HOUR)
ACCIDENTS AND INCIDENT INDEX
ACCIDENTS BY MI OR KM

### Logistics Variables

LOGISTIC CYCLE TIME
% OF EFFICIENCY PER DELIVERY POINT
% OF EFFICIENCY PER TRAILER;
UTILIZATION INDEX BY COMPRESSION STATION
LOADED VOLUME)
TRIP COUNTER
MI OR KM COUNTER
ARRIVALS BOARD (COMPRESSION STATION)
DEPARTURE BOARD (COMPRESSION STATION)
NATURAL GAS FINISHING BOARD (DELIVERIES POINTS)

### Operation and Maintenance Variables

% OF MAINTENANCE ORDERS EXECUTION
AMOUNT OF MAINTENANCE HOURS;)
STATISTICS ANALYSIS OF EQUIPMENTS ALARMS
STATISTICS ANALYSIS OF CORRECTIVE MAINTENANCE OCCURRENCES
STATISTICS ANALYSIS OF MAINTENANCE CAUSES
STATISTICS ANALYSIS OF SPARE PARTS USAGE
% OF EQUIPMENTS AVAILABILITY
ALARM OF NEXT PREVENTIVE MAINTENANCE

### Progress Control Variables

% OF DELIVERED VOLUME X BUDGET;
NEW PROJECTS START-UPS;
MAINTENANCE COST;
MAINTENANCE COST/DELIVERED VOLUME;
MAINTENANCE COST/BUDGET;
POWER CONSUMPTION/VOLUME;
CO₂ NO EMITTED;
DELIVERED VOLUME

1. A method for remote real-time control of compressed gaseous fuels transporting and distribution, wherein said method comprises the following steps:
a) automating the loading process of the trailer(s) which carries(y) the compressed gaseous fuels by providing instrumentation of: i) at least one Compression Station CS 112; ii) trailer(s) 114₁₋ₙ; and iii) Delivery Point(s) DPs 113₁₋ₙ, being monitored in real-time by at least one Control Room(s) 115;
b) based on the instrumentation provided to a), receiving in real-time telemetry information at a telemetry database DB 116 from the loading equipment of at least one of the Compression Station(s) CS 112, trailer(s) 114₁₋ₙ traveling during displacement, and from the unloading equipment of at least one of the Delivery Point(s) DP 113₁₋ₙ, wherein said telemetry data are processed by an application provided in said loading equipment of the Compression Station(s) CS 112, trailer(s) 114₁₋ₙ and unloading equipment of the Delivery Point(s) DP 113₁₋ₙ, then the processed telemetry data return as operation guidelines to the at least one Compression Station(s) CS 112, Trailer(s) 114₁₋ₙ and Delivery Point(s) DP 113₁₋ₙ as automation commands, and also being forwarded to the at least one Control Room(s) 115 as low-level variables for decision taking;
c) storing the received telemetry information in said telemetry database DB 116, uploading such information in real-time to a cloud database 120 supplied with at least two servers that run the said application and returning processed telemetry information to said telemetry database DB 116 as low-level variables for decision taking;
d) providing a logistics database DB 118, storing the received logistics information at said logistics database DB 118 uploading such information in real-time to the cloud database 120, and then returning processed logistics information to at least one Control Room(s) 115 as high-level variables for decision taking;
e) providing a maintenance database DB 117, storing received maintenance information at said maintenance database DB 117 uploading such information in real-time to the cloud database 120, and then returning processed maintenance information to at least one Control Room(s) 115 as high-level variables for decision taking;
f) providing a ERP database DB 119, storing received ERP information at said ERP database 119, uploading such information in real-time to the cloud database 120, wherein the combination of the data from steps (c), (d), (e) and (f) generates a united, standardized information for information crossing and backing-up, then forwarding processed ERP information to at least one Control Room(s) 115 as high-level variables for decision taking return;
g) based on the low- and high-level variables obtained at steps (b), (c), (d), (e) and (f), information crossing and backing up in real-time to create high level variables, the values of said variables being cross-checked by a logic defined in the system 100 to allow or not a certain operation, a stored application to run in the cloud database 120 showing the interface level to the at least one control room 115—to operate the system 100—and to the managing dashboard 130—to manage the system 100—based on statistics and KPI's 140, and receiving returned information from the at least one Control Room 115; and
h) managing the dashboard 130 to convey commands to the at least one Compression Station(s) CS 112, trailer(s) 114₁₋ₙ and Delivery Point(s) DP 113₁₋ₙ.

2. The method according to claim 1, wherein automating the loading process comprises the trailers 114₁₋ₙ being provided with a global positioning system (GPS) transmitter, a radio frequency identifiers (RFID) to store information related to model, preferred customer, planned maintenance and usage rate, and the Compression Station CS 112 and DP 113 being provided with instrumentation to store pressure, temperature, flowrate and volume data obtained from the measuring instruments of the Compression Station CS 112 and DP 113 and an antenna RFID for transmitting the blocks of information comprising the information obtained from CS 112, DP 113 and trailer 114 to the telemetry database 116.

3. The method according to claim 1, wherein the displacement times from CS 112 to DP 113₁₋ₙ and from DP 113₁₋ₙ to CS 112 are monitored/managed and evaluated in real-time to perform the dynamic adjustment of the logistics enabled by the position transmission of each trailer 114₁₋ₙ when passing through a determined check-point.

4. The method according to claim 1, wherein at DPs 113₁₋ₙ a trailer 114₁₋ₙ identification/recognition is installed using radio frequency identifiers (RFID), these being integrated with other variables selected among consumed volume, flow rate, pressure and temperature.

5. The method according to claim 1, wherein for each CS 112, trailer 114₁₋ₙ and DP 113₁₋ₙ there is a set of parameters that are transmitted, stored and processed, said parameters being monitored/managed by at least one control room 115.

6. A system for remote real-time control of compressed gaseous fuels transporting and distribution from at least one Compression Station CS 112 to Delivery Points DP 113₁₋ₙ through several Routes using Trailers 114₁₋ₙ loaded with said compressed gaseous fuel, wherein said system comprises:
a) telemetry 116, maintenance 117, logistics 118 and ERP 119 databases that provide low-level variables from the at least a first block of data collected from Compression Station CS 112, a second block of data collected from Delivery Point(s) DP 113₁₋ₙ and a third block of data collected from trailer(s) 114₁₋ₙ loaded with compressed gaseous fuel to at least two servers 121, 122 in the cloud database 120, one of the at least two servers being a back-up server;
b) the at least two cloud servers 121, 122 of a) providing: i) data to a dashboard 130 consisting either of a computer 131, a tablet 132 or a smart phone 133; ii) data to at least one control room 115ₙ, said at least one control room 115ₙ also providing data to the said at least two servers 121, 122; and
c) said system 100, comprising a logic, which performs crossing information in real-time and providing a crosschecking of the values of the high-level variables obtained from the merging of low-level variables obtained from said telemetry, maintenance, logistics and ERP databases, said crosschecking making possible present said high-level variables as customized variables controlled by a Control Room 115ₙ and managing level users, said users being able to make use of said correlations and/or of the existing variables and even add new variable combinations.

7. The system according to claim 6, wherein telemetry information is received at telemetry DB 116 from loading equipment at the at least one CS 112, from trailer(s) 114₁₋ₙ traveling during displacement, and from unloading equipment at DP 113₁₋ₙ the received information being stored in said telemetry database 116 and uploaded in real-time to a cloud database 120 with two DB servers 121, 122 able to run the application stored therein.

8. The system according to claim 6, wherein said system 100 interacts with two databases DB 121 and DB 122 having origin in telemetry DB 116, maintenance DB 117, logistics DB 118 and ERP DB 119.

9. The system according to claim 6, wherein the first level of cross-checked database information presented to control room 115 has origin in cross-checked information from telemetry 116, maintenance 117, logistics 118 and ERP 119 databases.

10. The system according to claim 6, wherein the second level of cross-checked database is the system 100 dashboard 130 intended to provide access to the whole control operation, based on KPIs 140 and accessed either from a computer 131, smart phone 132, or tablet 133.

11. The system according to claim 6, wherein for said system levels, in a first step, information is stored in separated databases, as low level variables, then, in a second step, a sole database 120 cross-check and back-up information, as high-level variables and, in a third step, standardized data is provided using different interfaces for automation of the system.

12. The system according to claim 11, wherein to provide information to the first step, the instrumentation level comprises data acquired by instruments installed at compression stations CSs 112, trailers 114₁₋ₙ and delivery points DP 113₁₋ₙ and information is stored at the telemetry database 116.

13. The system according to claim 12, wherein the instrumentation level further comprises data entered by HMI (human machine interface), computers 131, smartphones 132 and tablets 133, which are stored in maintenance 117, logistics 118 and ERP 119 databases.

14. The system according to claim 6, wherein the second database level comprises parameters and information having origin in telemetry 116, maintenance 117, logistics 118, and ERP 119 databases, which are stored together in both servers 121, 122 that also run the application and shows the interface to the control room 115 and the managing dashboard 130.

15. The system according to claim 14, wherein the second database level provides cross-checked information between the physical quantities read by the telemetry 116 database and the databases from maintenance 117, logistics 118 and ERP 119, generating standardized information for the interface level.

16. The system according to claim 15, wherein the interface level is where said system 100 is operated by the control room 115 and monitored by the managing dashboard 130.

17. The system according to claim 6, wherein high-level information is obtained by taking the low-level variables from each of telemetry 116, maintenance 117, logistics 118 and ERP 119 database, merging said databases, enabling real-time information crossing leading to high level variables, these, in turn, according to a logic defined into the system, which will crosscheck the values of the created high-level variables allowing or not a certain operation.

18. The system according to claim 6, wherein said system access comprises platforms selected among a Web platform, a proprietary platform and a mobile platform.

19. The system according to claim 6, wherein the use of the access platform for each individual user enables said system to be separated into areas related to Management, Engineering, Logistics and Operation and Maintenance.

20. The system according to claim 19, wherein the Management Area: i) provides consolidated information related to managing dashboard 130 KPI's 140 box; and ii) is separated into two subdivisions, Corporate, with access to information on operations; and regional, with limited access to projects and equipment that are part of its operation.

21. The system according to claim 19, wherein the Engineering Area visualizes, controls and manages the information on areas and access platforms.

22. The system according to claim 19, wherein the Logistics Area (Control Room 115) has custom access to information concerning the company's equipment operation including logistics variables.

23. The system according to claim 19, wherein the Operation and Maintenance Areas has access to equipment requiring real-time monitoring including process equipment at DPs 113, said equipment being monitored, remotely operated and having its reference values (Set Points) being adjusted.
